(19) United States
(12) Patent Application Publication
(10) Pub. No.: US 2014/0082627 A1
(43) Pub. Date: Mar. 20, 2014

(54) PARALLEL COMPUTE FRAMEWORK

(71) Applicant: SYNTEL, INC., Troy, MI (US)

(72) Inventor: CHETAN MANJAREKAR, PUNE (IN)

(73) Assignee: SYNTEL, INC., Troy, MI (US)

(21) Appl. No.: 14/022,652

(22) Filed: Sep. 10, 2013

Related U.S. Application Data
(60) Provisional application No. 61/701,210, filed on Sep. 14, 2012.
(60) Provisional application No. 61/778,649, filed on Mar. 13, 2013.

(51) Int. Cl. G06F 9/50

(52) U.S. Cl. CPC G06F 9/5027
USPC 718/104

(57) ABSTRACT

A computerized system, method and program product for executing tasks in parallel, including but not limited to executing tasks in combination on multiple processors of multiple computers and/or multiple cores of a processor on a single computer and/or combinations thereof. The framework utilizes parallel computing design principles, but hides the complexities of multi-threading and multi-core programming from the programmer.

### RELATED APPLICATIONS

The present application is related to and claims priority to U.S. Provisional Patent Application Ser. No. 61/701,210 filed Sep. 14, 2012, entitled “Parallel Compute Framework” and U.S. Provisional Patent Application Ser. No. 61/778,649 filed Mar. 13, 2013, entitled “Parallel Compute Framework.” These applications are hereby incorporated by reference into the present application in their entireties.

### TECHNICAL FIELD

This disclosure relates generally to computerized systems and processes; in particular, this disclosure relates to a computerized framework for enhancing the performance of applications by using parallel computing.

### BACKGROUND AND SUMMARY

Multi-processor machines are now becoming more common and memory has become very inexpensive. Despite this, most business applications fail to reap the benefits of these advances in hardware technology because current application architectures do not leverage multi-core processors. This results in low application performance and underutilization of resources.

One difficulty in taking advantage of a machine's multi-processor capabilities is the complexity of writing the business applications with parallel computing programming. This type of programming tends to be more complicated than the business logic to which the programmers are accustomed to writing.

According to one aspect, this disclosure provides a framework that utilizes parallel computing design principles, but hides the complexities of multi-threading and multi-core programming from the programmer. By hiding the multi-threading and multi-core programming aspects, the programmer's productivity is enhanced by only concentrating on business logic and not complex parallel computing programming. This use of parallel computing design drastically improves the application performance and ensures optimal usage of the hardware resources. Since the framework is separated from the business code, parallel computing can be integrated into existing applications.

Embodiments are contemplated in which a dashboard could be provided for purposes of task monitoring and audit statistics. Robust exception handling could also be provided to automatically log errors to a database. For example, the error processing module could be used to halt or proceed in the case of an exception depending on the configuration of the system.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a diagrammatic view of an example machine that could be used to execute one or more of the methods described herein;

FIG. 2 is a diagrammatic view of the parallel compute framework according to one embodiment;

FIG. 3 is a diagrammatic view of a target application using the parallel compute framework according to one embodiment;

FIG. 4 is a flow chart showing example steps that may occur in the parallel compute framework;

FIG. 5 is an example code snippet showing a potentially time consuming portion of code that could be optimized using the parallel compute framework;

FIG. 6 is the domain model for the creation of a task;

FIG. 7 is the domain model for the partitioner and map reducer;

FIG. 8 is the domain model for Compute and Data Parallelism;

FIGS. 9-21 are diagrammatic views of example implementations of the parallel compute framework in various industries;

FIGS. 22-24 illustrate an embodiment with a balanced file partitioner.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates generally to a computerized system and method for executing tasks in parallel, including but not limited to executing tasks in combination on multiple processors of multiple computers and/or multiple cores of a processor on a single computer and/or combinations thereof. The terms “parallel computing” and “multi-processor computing” are broadly intended to encompass the notion of using two or more processors (e.g., cores, computers, etc.) in combination to perform a task or set of tasks. The set of tasks is generally broken into pieces that each may be performed on different processors/cores. The processors/cores may be on a single computer or on a set of computers that are networked together. A “task” is broadly intended to represent any computing function (or portion of a function) to be performed, regardless of the type of application and/or business logic associated with the task. As should be appreciated by one of skill in the art, the present disclosure may be embodied in many different forms, such as one or more machines, computerized methods, data processing systems and/or computer program products.

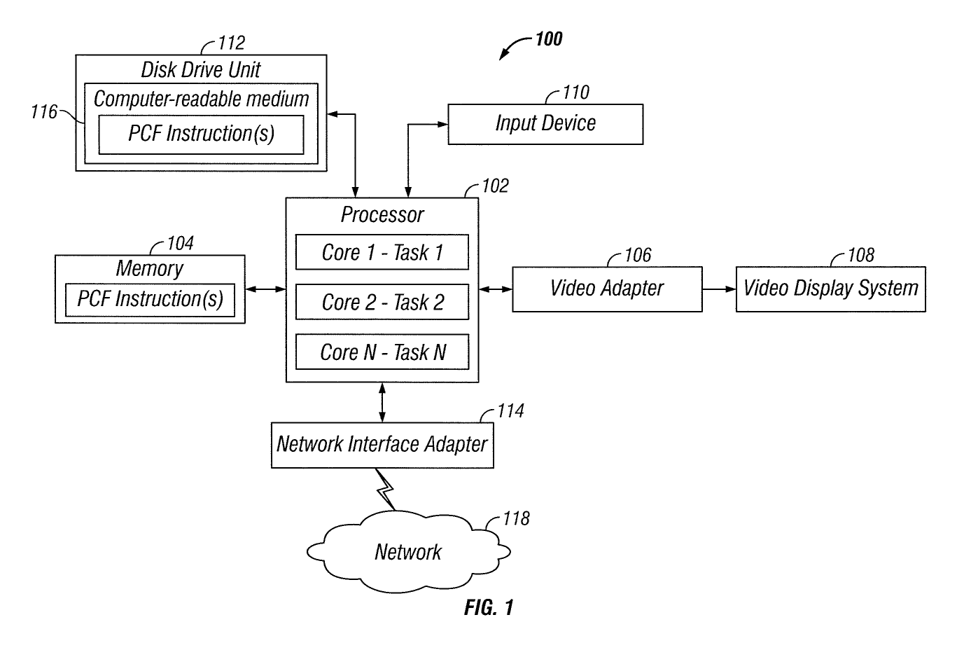

FIG. 1 illustrates a diagrammatic representation of a machine 100 in the example form of a computer system that may be programmed with a set of instructions to perform any one or more of the methods discussed herein. The machine 100 may be any machine or computer capable of executing a set of instructions that specify actions to be taken by that machine. As discussed below, the instructions may be executed in parallel with multiple cores on the machine or in conjunction with other machines.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. In embodiments where the computer program is locally stored, data may be retrieved from local storage or from a remote location via a network. In a networked deployment, the machine 100 may operate in the capacity of a server or a client machine in a server-client network environment, or as a peer machine in a peer-to-peer (or distributed) network environment. Although only a single machine is illustrated in FIG. 1, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. As discussed above, embodiments are contemplated in which the CPU may include multiple cores for executing instructions in parallel. Note that various embodiments of the machine 100 will not always include all of these peripheral devices.

The disk drive unit 112 includes a computer-readable medium 116 on which is stored one or more sets of computer instructions and data structures embodying or utilized by one or more of the methods described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the instructions associated with the parallel compute framework may be transmitted or received over a network 118 via the network interface device 114 utilizing any one of a number of transfer protocols including but not limited to the hypertext transfer protocol (“HTTP”) and file transfer protocol (“FTP”). The network 118 may be any type of communication scheme including but not limited to fiber optic, wired, and/or wireless communication capability in any of a plurality of protocols, such as TCP/IP, Ethernet, WAP, IEEE 802.11, or any other protocol.

While the computer-readable medium 116 is shown in the example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

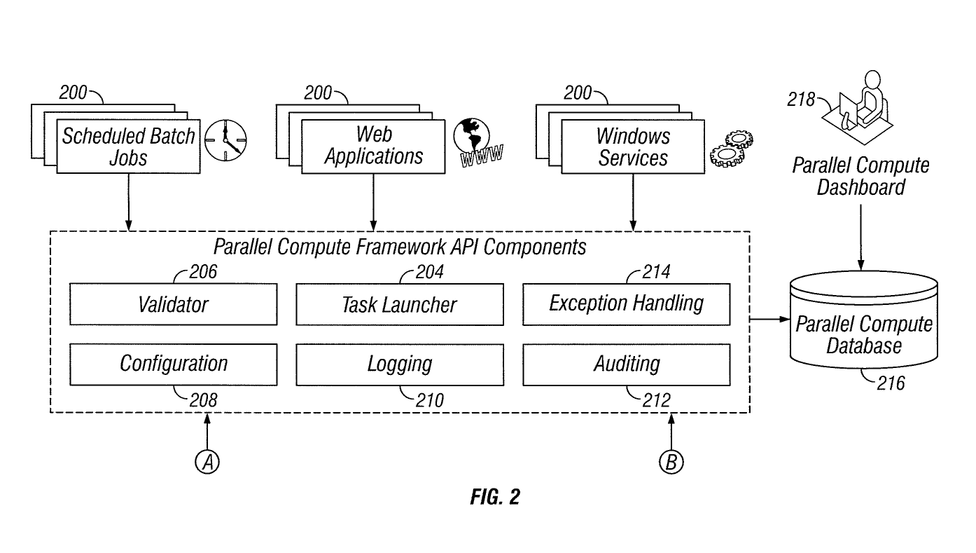

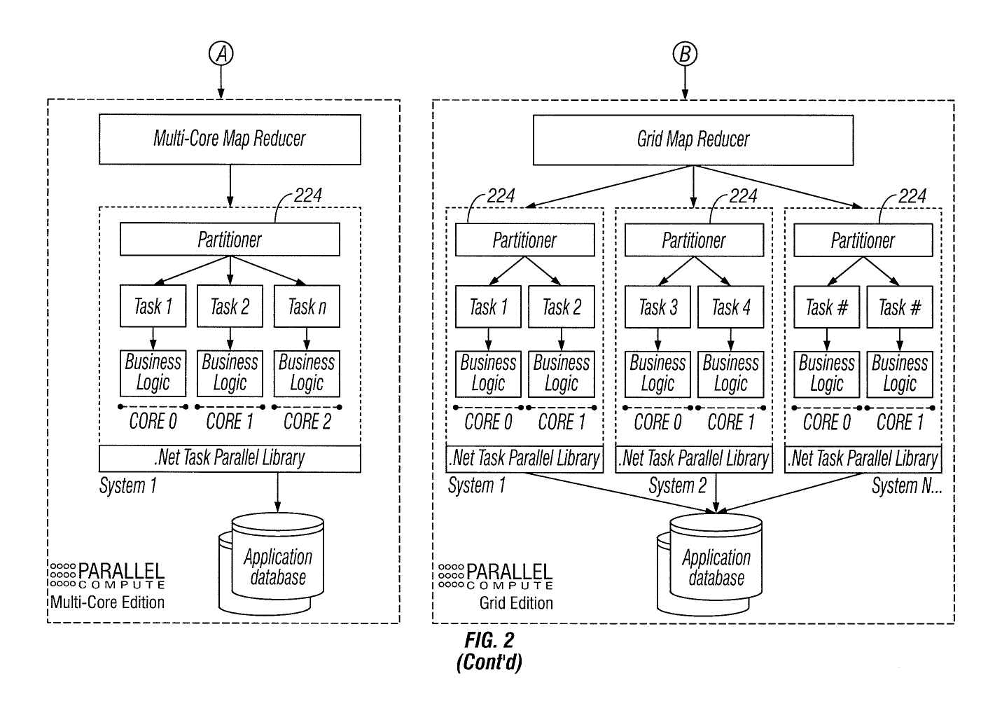

FIG. 2 is a diagrammatical representation of an embodiment of a system using the parallel compute framework. In the embodiment shown, the parallel compute framework is based on a service oriented architecture (“SOA”). For example, the parallel compute framework may be a service that could be used by a variety of applications 200. For purposes of example only, a variety of example applications are shown, such as scheduled batch jobs, web applications, and background running services, that could take advantage of the parallel compute framework. One skilled in the art should appreciate that other applications other than those shown in FIG. 2 could be used in conjunction with the parallel compute framework.

As shown, the parallel compute framework includes example components that could be part of the API 202 to provide a manner by which applications can interface with the framework to be scheduled and executed in parallel. In the example shown, the API 202 includes a task launcher 204, which is the entry point into the parallel compute framework and takes responsibility for launching a PCF task. A PCF task is a basic unit of code that needs to be executed in parallel. There can be multiple tasks that need to be executed one after another to achieve the business functionality. The business logic can be wrapped within a PCF task to be executed.

In the embodiment shown, the API 202 includes a validator 206 to determine whether the parameters supplied are those required to invoke a PCF task. In some embodiments, the validator 206 is exposed to developers to extend the requirements needed to validate the parameters. For example, the developers could customize the validator 206 to add additional parameters required to invoke a PCF task. Likewise, the developers could customize the validator 206 to reduce the parameters needed to invoke a PCF task.

In some cases, the API 202 includes a configuration component 208, which could be a configuration file that sets the parameters for the PCF. For example, some or all of the parameters for the framework could be configured in a “config” file using the various configuration settings, such as the input parameters, validators, tasks, partitioner, etc.

In the example shown, the API 202 includes a logging component 210, an auditing component 212 and an exception handling component 214. The logging component 210 is configured to log actions taken by components of the API 202, such as communications between API components and applications. The auditing component 212 may be used to audit actions taken by components of the API 202. The exception handling component 214 may be used to halt or proceed with processing depending on certain circumstances, such as improper parameters passed to the API 202. Information from these components 210, 212, 214 could be stored in a database 216, which could be accessed by a dashboard 218.

In the embodiment shown, the parallel compute framework includes a multi-core map reducer 220 and a grid map reducer 222. As shown, the multi-core reducer 220 includes a computer system with a core 0, core 1, and core 2 on which a task 1, task 2 and task n are executed. Although three cores are shown in the computer system for purposes of example, two cores or more than two cores could be provided depending on the circumstances. The grid map reducer 222 is similar to the multi-core map reducer 220, but it includes multiple computer systems each with multiple cores in the example shown. For example, the grid map reducer 222 may distribute tasks among a system 1 with a core 0 and core 1, a system 2 with a core 0 and a core 1, and a system n with a core 0 and a core 1. Although three systems are shown in this example, the grid map reducer 222 could be associated with two systems or more than two systems. These map reducers 220, 222 would generally be two of the options available for implementing the parallel compute framework. Although this example shows both map reducers 220, 222, only the multi-core map reducer 220 or the grid map reducer 222 could be provided depending on the circumstances.

As shown, both reducers 220, 222 include a partitioner 224. The partitioner 224 is primarily used to partition the data based on a criteria of which can be executed in parallel. The basic version of the parallel compute framework provides a basic task node partitioner which partitions based on the number of partitions configured in the application. Other configurations are also possible.

In one embodiment, the tasks are partitioned based on the available processors (or cores) and distributed across these processors or cores for execution. The parallel compute framework in some embodiments is available in .Net™ and embodiments are contemplated in Java™ as well. The following are supporting libraries used in these embodiments:

| Variant | Supporting Library Names |
|---|---|
| .Net | Task parallel library (“TPL”) |
| | Enterprise library for cross cutting concerns |
| Java | JSR166y and java.util.concurrent package |
| | Log4j for logging |
| | Hibernate as ORM |

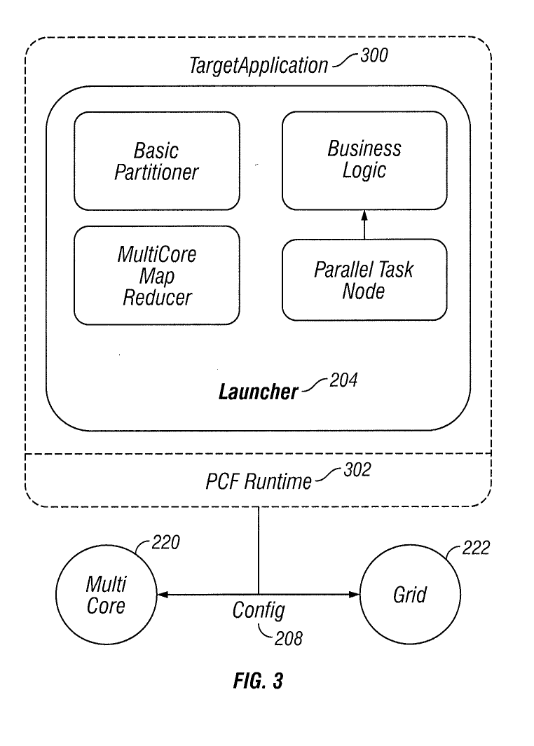

FIG. 3 is a diagrammatical view showing a target application 300 utilizing the parallel compute framework. In this example, the target application includes computer code to invoke the task launcher 204. Assuming the proper parameters are used, which is checked by exception handling 214, the PCF runtime 302 will direct the tasks to either the multi-core map reducer 220 or grid map reducer 222, depending on the configuration component 208, to execute the tasks in parallel using the Task parallel library (“TPL”).

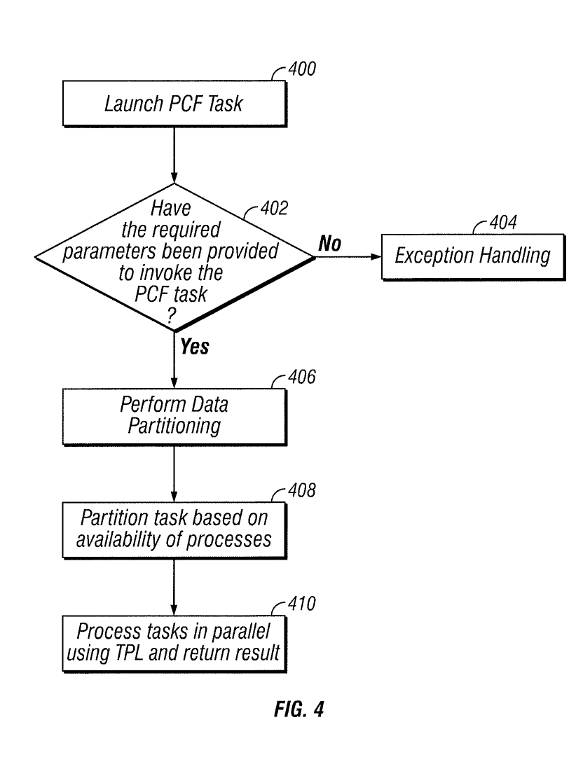

FIG. 4 shows example steps that could be performed as tasks are executed in parallel. The target application includes code that invokes the PCF task launcher 204 as shown in Block 400. The validator 206 checks, among other things, the parameters that have been provided to determine whether the required parameters have been provided to invoke the PCF task as shown in Block 402. If the required parameters have not been provided, exception handling 214 may halt the process as shown in Block 404. If the required parameters were provided, the data associated with the task will be partitioned by the partitioner 224 as shown in Block 406. Likewise, the task may be broken up into discrete pieces to be executed on different cores/processors as shown Block 408. The partitioned tasks are then performed in parallel using parallel programming APIs and a return result as shown in Block 410.

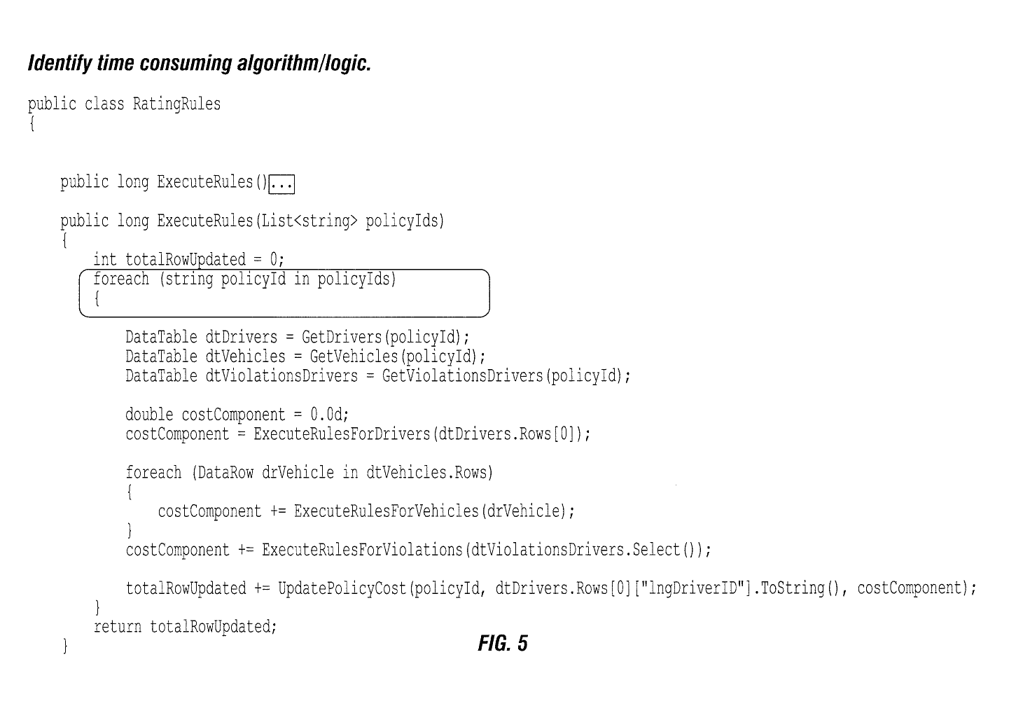

As an example industry that could utilize the parallel compute framework, insurance firms run processes for identifying policies that are about to lapse and calculate the new premium for those policies according to the new rating rules. The rating rules engine applies business logic on driver demographics, vehicle info and violations data to calculate the premium for the new policy. This can lead to very time consuming processing. FIG. 5 shows an example code snippet for this type of environment/implementation that could benefit from the parallel compute framework. In this example, a “foreach” loop is circled to identify that this portion of the code may be time consuming. As shown, the “foreach” loop will perform one or more tasks for each “policyId.” Since the actions for each “policyId” will be performed sequentially, this could be time consuming and therefore could benefit from the parallel computer framework. The parallel compute framework could be used to enable the policy renewal process to be completed in a short span of time by partitioning the records into discrete datasets that can run on local CPU cores or distributed CPU cores (grid).

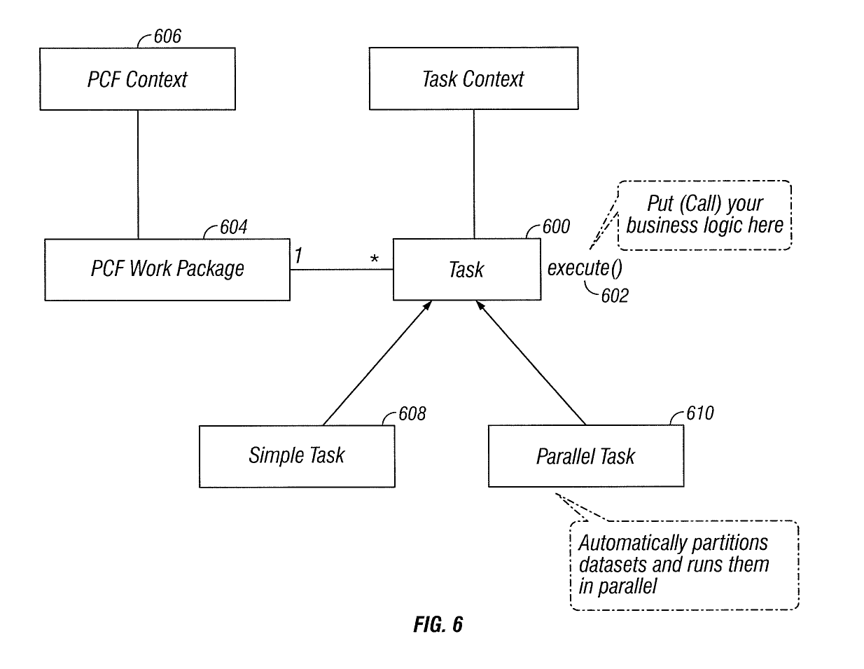

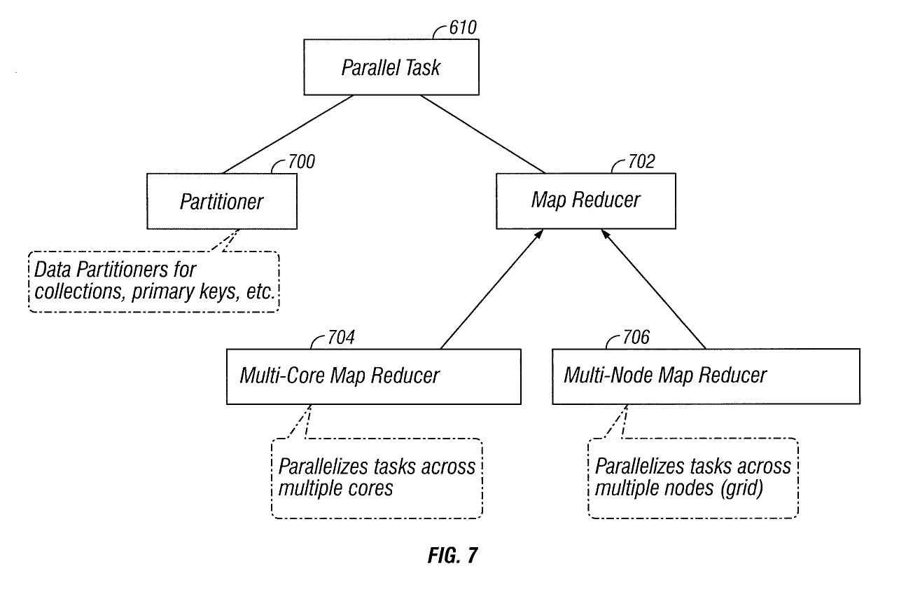

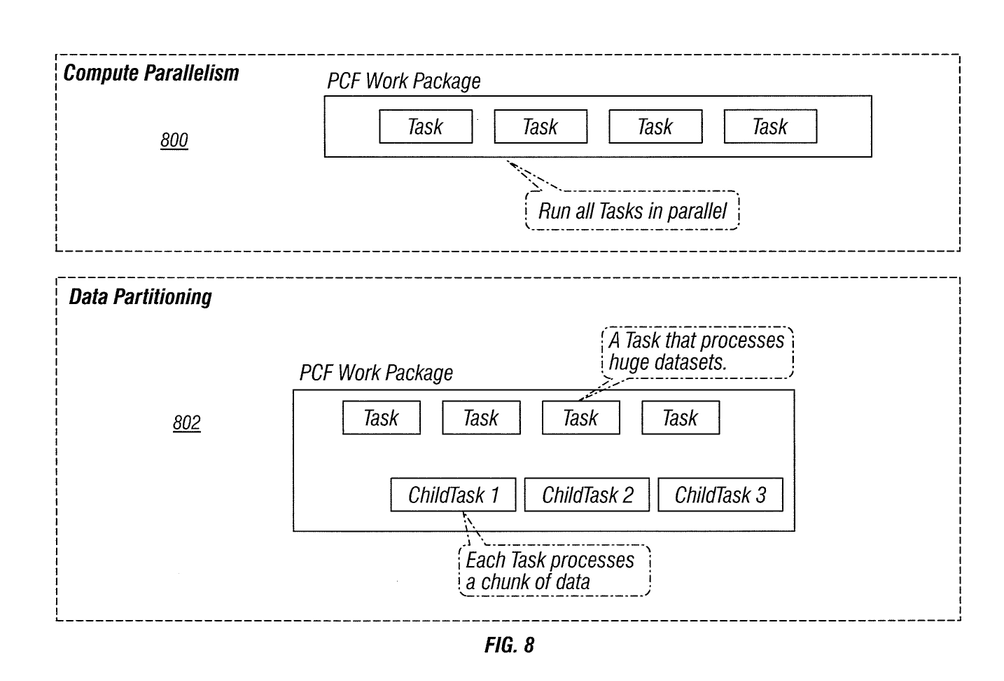

FIGS. 6-8 show a high level domain model of the parallel compute framework according to one embodiment. FIG. 6 shows a task 600 in the context of the domain model. In this embodiment, a task 600 is the fundamental domain object of the parallel compute framework. It exposes a template where time consuming business logic may be written inside the execute routine 602. Task related data can be stored in the PCF content. The collection of tasks builds a work package 604 and all tasks can share interchangeable data in the PCF context 606. A task could be of a simple 608 or parallel 610 type of task. FIG. 7 shows the parallel type of task 610 in the domain model. In this example, the parallel task 610 is associated with a PCF partitioner 700 and a map-reducer 702. The PCF partitioner 700 decides how to partition. For example, it could be a collection, primary-key or custom chunking logic. The map-reducer 702 decides how to distribute the partitioned data/task to the multi-core reducer 704 for distribution to multiple cores of a machine or to the multi-node map reducer 706 for distribution to multiple nodes of a grid. The parallel compute framework's flexible component driven architecture allows switching from the multi-core map reducer to the multi-node map reducer by just a line of configuration changes without altering the business logic. As shown in FIG. 8, the parallel compute framework supports compute parallelism 800 and data parallelism 802. To exemplify the technique of compute parallelism for example purposes only, consider an example in which within a work package there are four tasks. The parallel compute framework compute parallelism will enable running those fours task concurrently. With respect to data parallelism, tasks are executed sequentially and each task can spawn “n” number of child tasks to execute chunk of data independently.

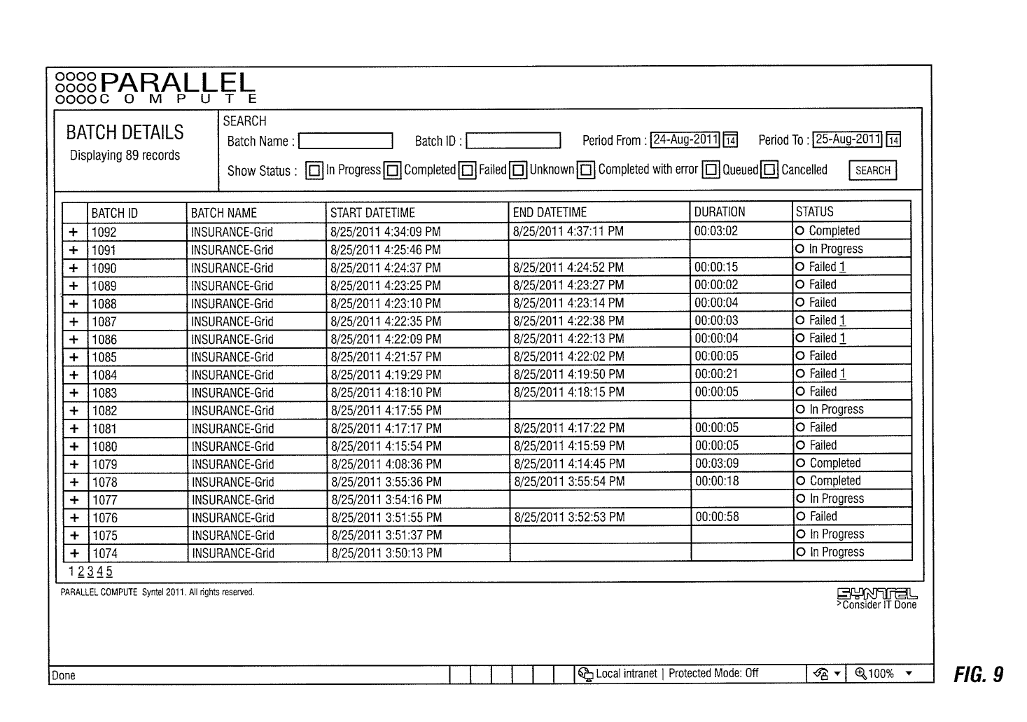

FIG. 9 is a screen shot of an example dashboard according to one embodiment. The dashboard delivers data visualizations in a format optimized for quick absorption. This dashboard lets an administrator bring the parallel compute framework data to life with clarity for monitoring and diagnosis. In one embodiment, the dashboard has the following capabilities:
Designed to offer you run time transparency of PCF.
Easy-to-use and instant access to the number of partition, Task and Map reduce information.
Summarizes the data associated with PCF work package.
Provides links to view exceptions of your task.

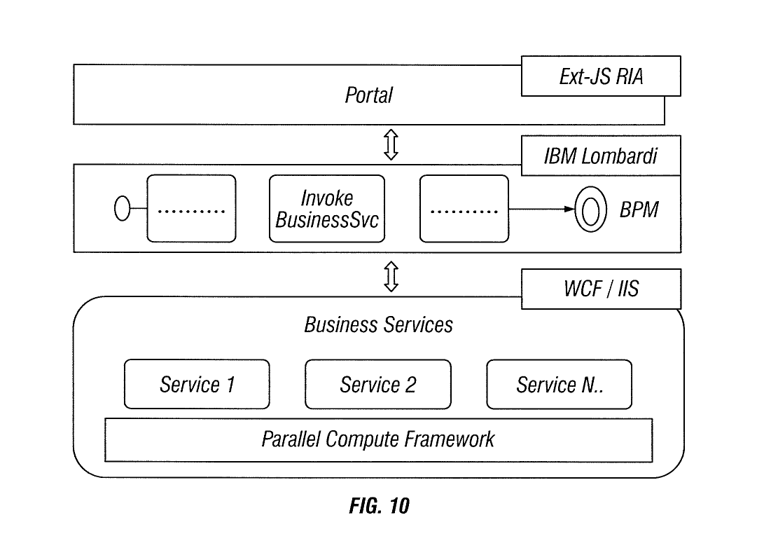

FIG. 10 shows an example implementation of the parallel compute framework with a financial services company. In this example, the company embarked on a BPM/SOA enterprise initiative, but there were many BPM processes that had to load/transform data from various sources. The example shows the process for data loading and data transformation using the parallel compute framework exposed as a service, which enabled it to be called by the IBM BPM process manager. In this example, there is a portal 900 that could take the form of various web applications, such as Rich Internet Applications (“RIA”) using a variety of languages, such as the product by the name of JavaScript by Oracle of Redwood Shores, Calif. These applications may communicate with business process management software, such as the product by the name of IBM Lombardi by IBM of Armonk, N.Y. In this example, business services, including the parallel compute framework, are exposed through Windows Communication Foundation (“WCF”) by Microsoft Corporation of Redmond, Wash. This allows the parallel compute framework to be called by the business process manager, which enhances processing time by executing tasks in parallel. In this example, development efforts were accelerated by 30% and batch jobs ran about 60% quicker using the parallel compute framework.

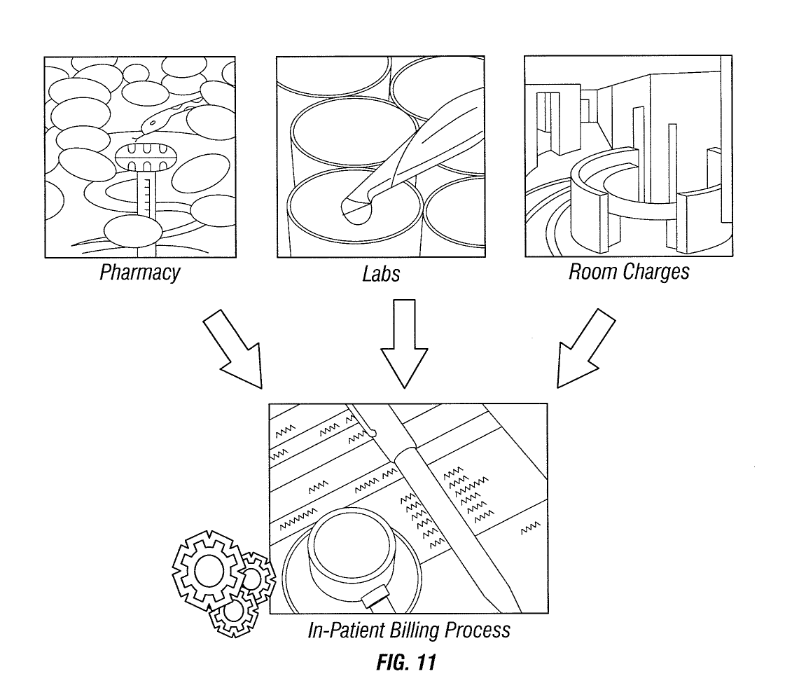

FIG. 11 is a diagrammatic view of another type of implementation where the parallel compute framework could be used. In this example, a hospital (or other entity) typically runs a lot of batch jobs at the end of the day for various housekeeping tasks. One such process is the daily billing process that calculates the outstanding amount for all in-patients. The billing systems will aggregate data from other departments, such as charges from pharmacy unit, labs, room administration, etc. to complete the billing process. The parallel compute framework enables the billing process to be completed in a short span of time by partitioning the records into discrete datasets that can run on local CPU cores using the multi-core map reducer or distributed CPU cores using the grid map reducer. The billing process runs faster and can easily meet the business service level agreements (“SLAs”). The developer would only need to write business logic and configure the parallel compute framework for either vertical scaling (multi-core map reducer) or horizontal scaling (grid map reducer).

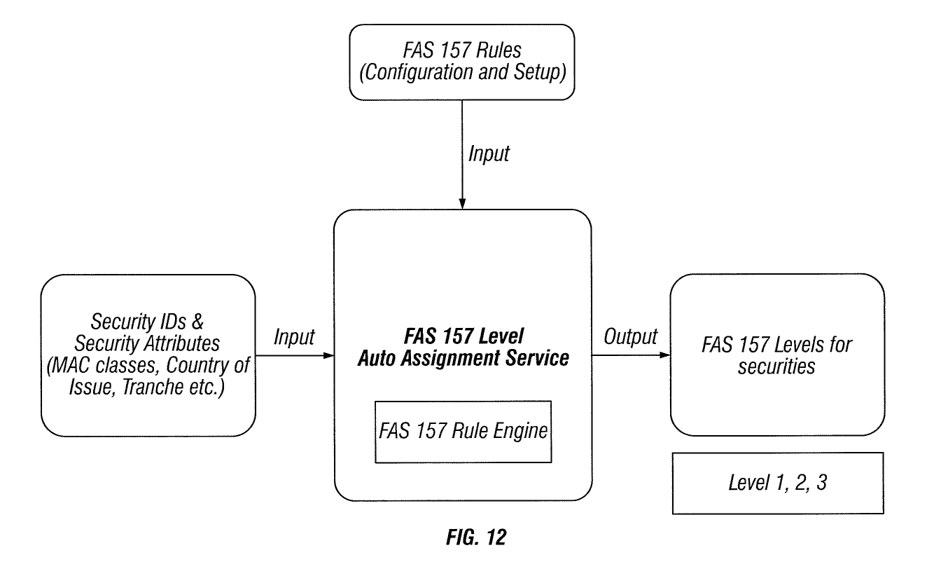

FIG. 12 shows example implementation in the accounting industry in which the parallel compute framework could be used to speed processing. FAS 157 is an accounting standard that defines fair value and establishes a framework for measuring fair value of financial instruments. FAS 157 is mandatory for financial statements prepared in accordance with GAAP. Hence all investment management firms need to calculate FAS levels of securities in their portfolio. The parallel compute framework enables the FAS 157 leveling process to be completed in a short span of time by partitioning the records into discrete datasets that can run on local CPU cores or distributed CPU cores (grid). The FAS 157 process runs faster and can easily meet the business SLAs. The developer just writes the business logic and configures the parallel compute framework for either vertical scaling (multi-core) or horizontal scaling (grid).

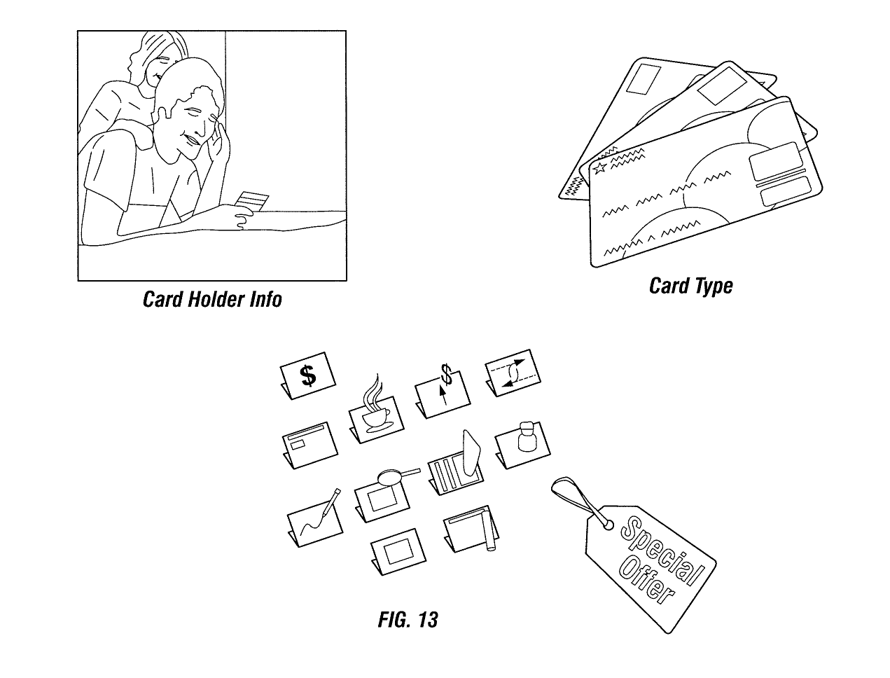

FIG. 13 shows an example implementation of the parallel compute framework in the financial services industry. Credit card issuers regularly run promotions to sell new offers to card holders. The eligibility for various offers is determined based on parameters such as customer information, demographics and card type. These offers are then rolled-out to customers through multi-channel delivery options such as email, SMS and voice. The parallel compute framework enables the promotion process to be completed in a short span of time by partitioning the records into discrete datasets that can run on local CPU cores or distributed CPU cores (grid). The promotion process runs faster and can easily meet the business SLAs. The developer would write business logic and configure the parallel compute framework for vertical scaling (multi-core) or horizontal scaling (grid).

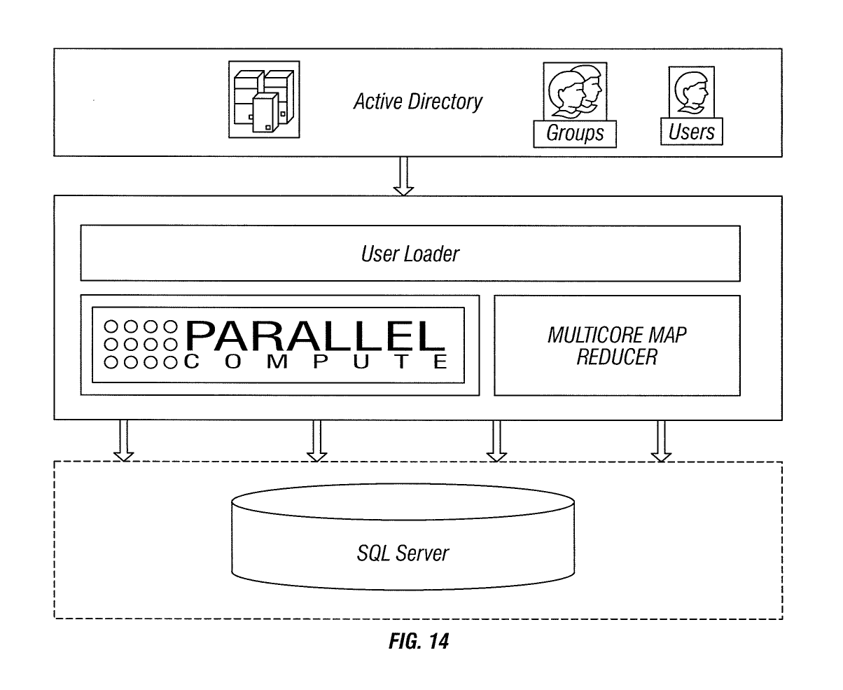

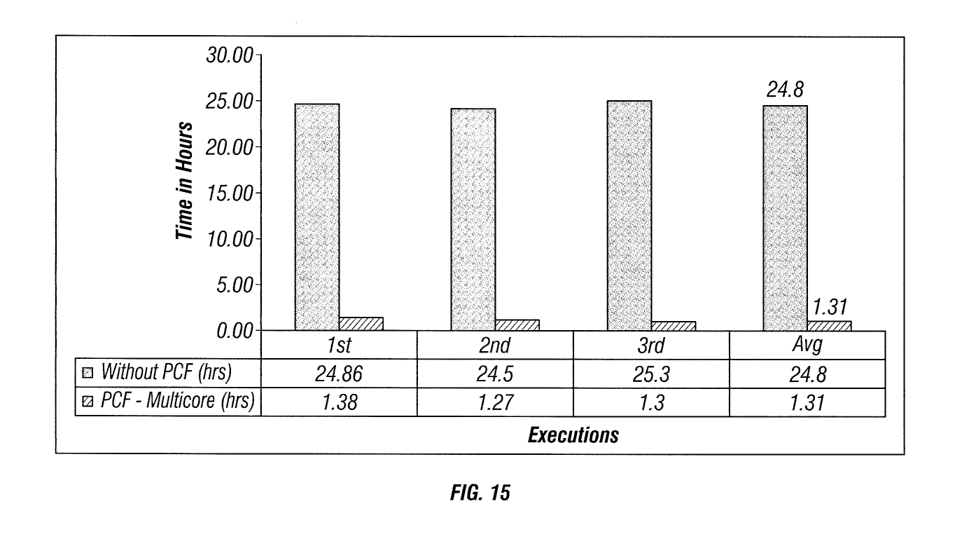

FIG. 14 shows an example implementation at an insurance firm. In this example, there is SLA management and application maintenance of a business' end of day process that would synchronize users between Active Directory and SQL server. With over 120,000 users in the active director for which this sync operation executed daily, it took about 23 hours to complete. With the use of the parallel compute framework for parallel processing of the users, this accelerated performance by 94% and the application could complete execution in less than 1.5 hours. Multi-core programming and map reduce patterns were used to improve performance as can be seen by the graph in FIG. 15.

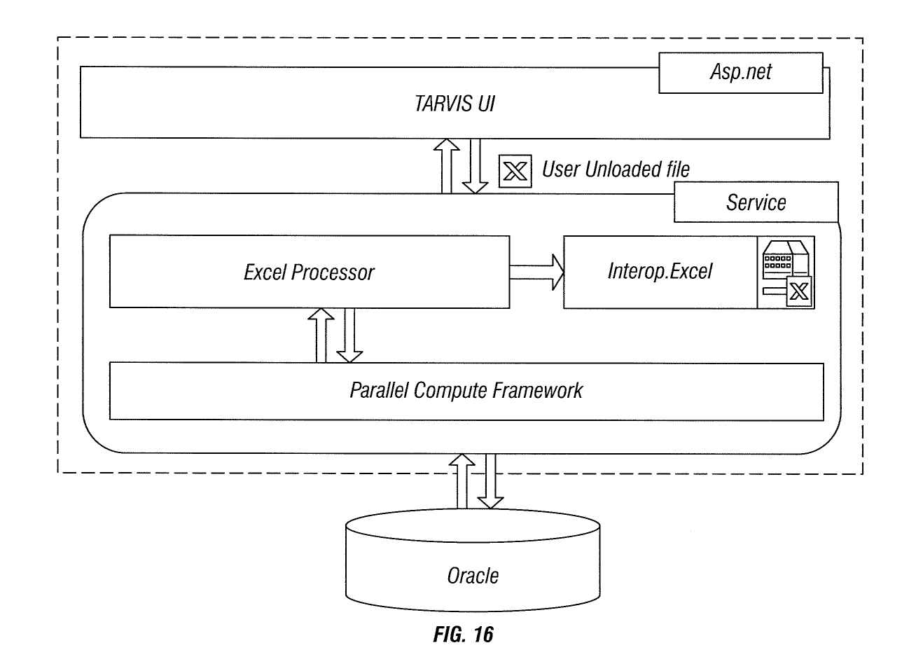

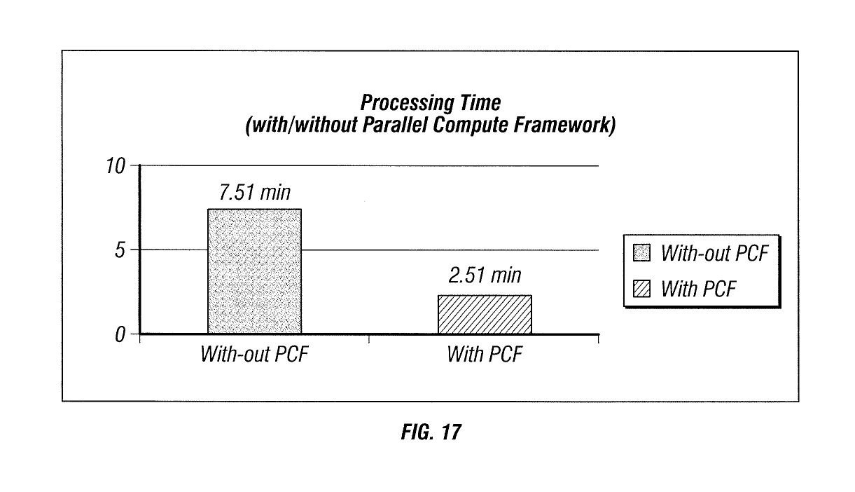

FIG. 16 shows an example implementation of the parallel compute framework at an insurance firm. In this example, there is SLA management and maintenance of a customer's application called “TARVIS” that was used for updating enterprise financial journals. Using the TARVIS UI module, users uploaded a variety of Excel files and the data in the files were processed and persisted by the TARVIS service component. For large files, the processing times were greater than 8 minutes, resulting in a poor user experience. The parallel compute framework was used for processing of Excel contents. With this change, development efforts were reduced by 30% and the TARVIS service ran faster due to the multi-core parallel processing—around 66.6% quicker as can been seen by the graph in FIG. 17.

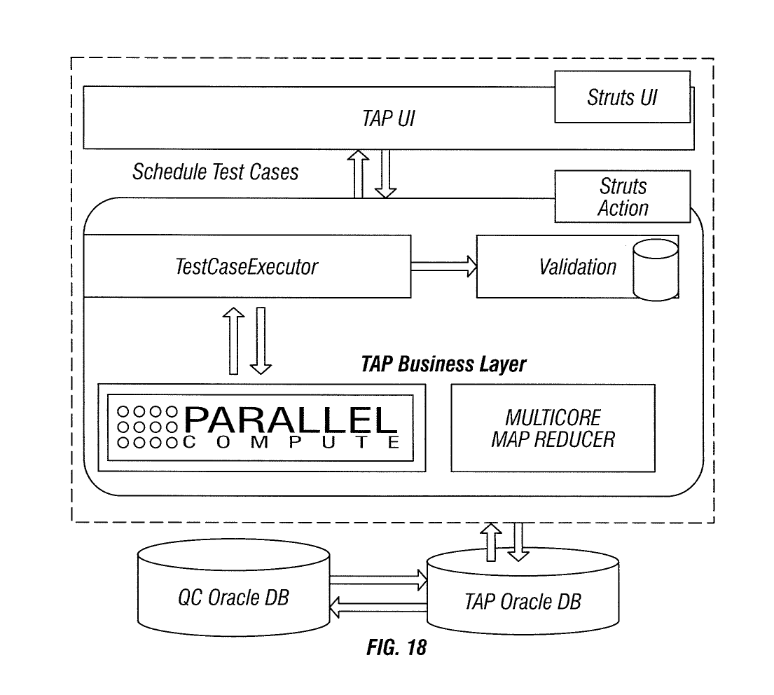

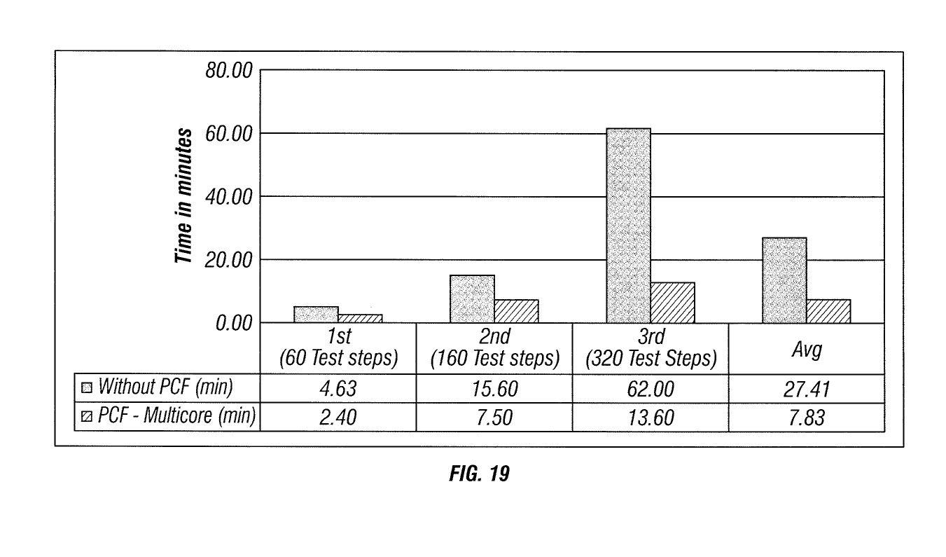

FIG. 18 shows an example implementation of the parallel compute framework at a logistics firm. This project involved development and maintenance of an end-to-end automated testing solution aimed at producing a simple unified and intelligent testing suite for all enterprise applications. A large number of exhaustive test cases were to be executed (˜2000 test cases per run) under compressed timelines. The test runs were over-shooting the client-set SLAs. The parallel compute framework for parallel processing of the test cases improved performance of the testing suite with a 75%-85% reduction in processing timelines, as can be seen in the graph of FIG. 19.

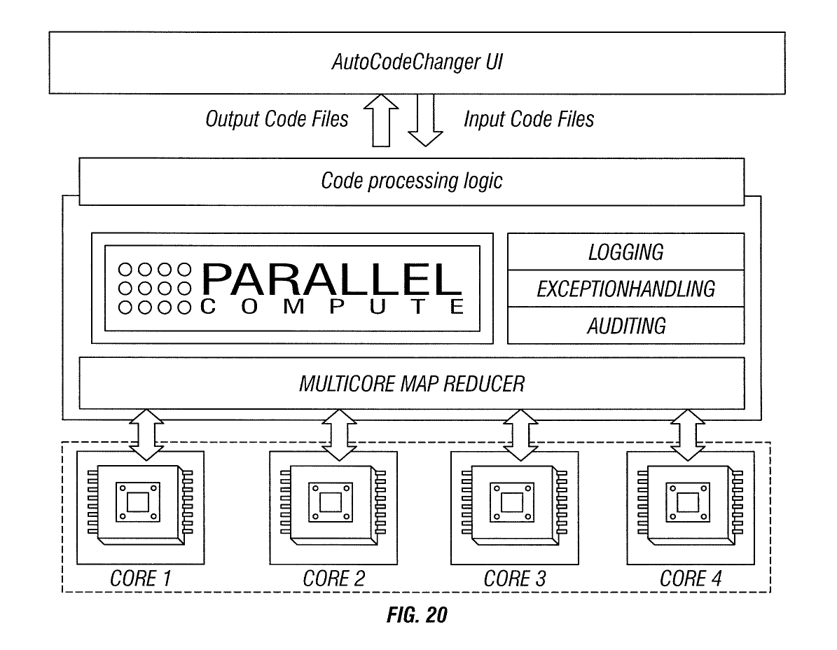

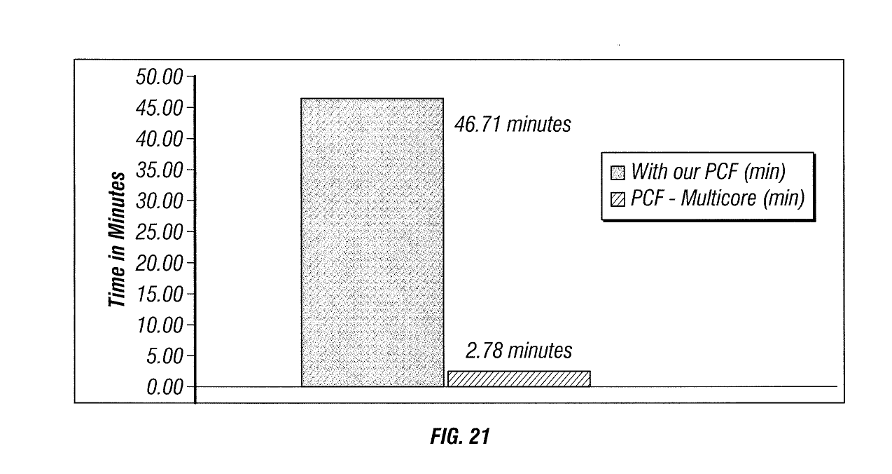

FIG. 20 shows an implementation of the parallel computer framework in conjunction with a cost-effective tool developed to meet the ICD-10 remediation requirements of legacy and open system applications. One feature of the tool allows migration of ICD-9 codes to ICD-10 codes in legacy applications, but this migration was taking a substantial amount of time, especially for large code bases. The use of the parallel compute framework reduced development efforts by 30%. The performance was 20 times faster (i.e., 93% reduction in processing time). This was achieved with minimal impact to the existing code base (only 2 files in the original code base were changed). FIG. 21 is a graph that illustrates the improved performance.

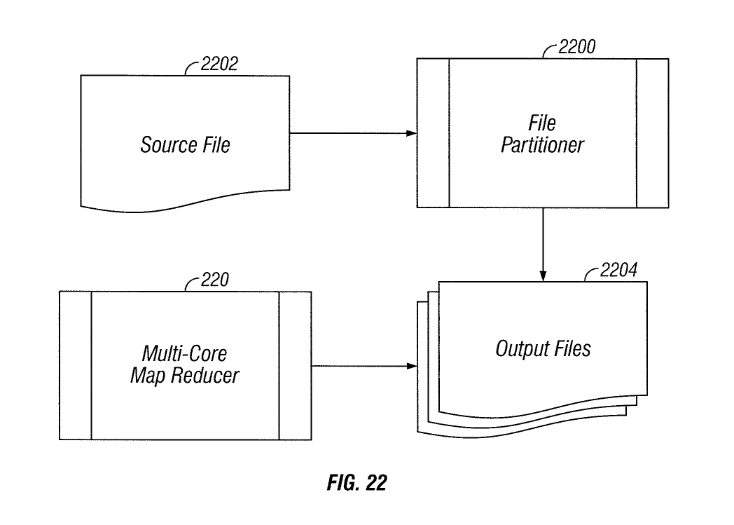

FIG. 22 shows an embodiment of the parallel compute framework that includes a balanced file partitioner 2200. This component accepts a source file(s) 2202 as input and almost evenly partitions the data stream and distributes the file across multiple processors or nodes of a grid using the PCF map reducer 220. Conceptually, the design of the balanced file partitioner 2200 is very simple, as shown in FIG. 22. This partitioner 2200 reads a given input file(s) 2202 passed in as arguments, which is partitioned based on industry accepted algorithm (the algorithm may consider size, length, number of rows and other file system metadata) and produces multiple chunks of the original data file 2204. These chunks will then be processed by the PCF map reducer 220.

Consider an example with a comma separated file, such as order.txt, which has 10,000,000 rows. The order.txt file is a simple text file which holds some order information such as OrderID, Purchase Date, Shipment Date, and Amount. The balanced file partitioner 2200 takes this file as a single input and creates three partitions (assuming in this example that the number of partitions is configured as 3) in an almost equal proportion to its various outputs. Every output of the partitioner 2200 is supposed to receive 333333 numbers of rows. Below is a table showing sample output for the three partitioned files:

| File Name | Order ID | Number of records |
|---|---|---|
| Order 1.csv | Order Id from 1 to 333333 | 333333 |
| Order2.csv | Order Id from 333334 to 666667 | 333333 |
| Order3.csv | Order Id from 666668 to 1000000 | 333334 |

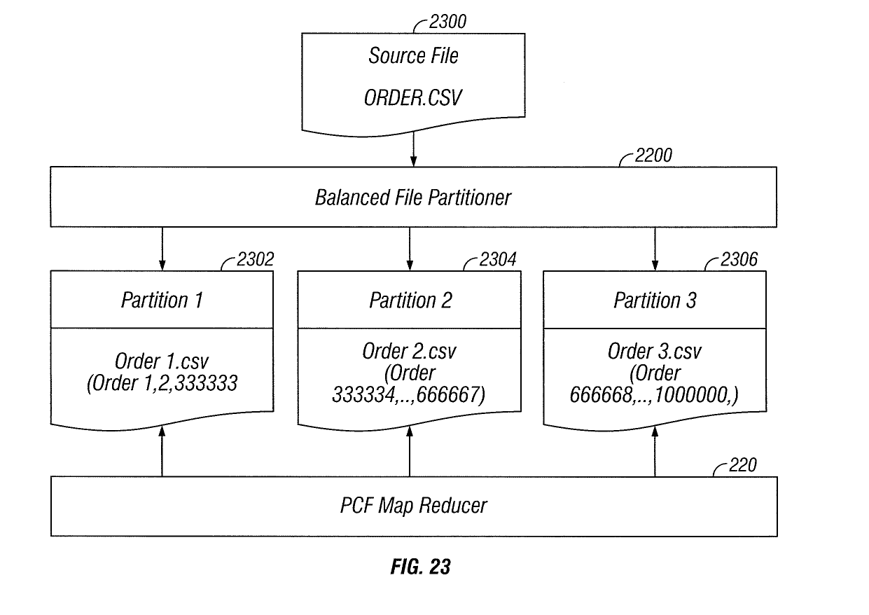

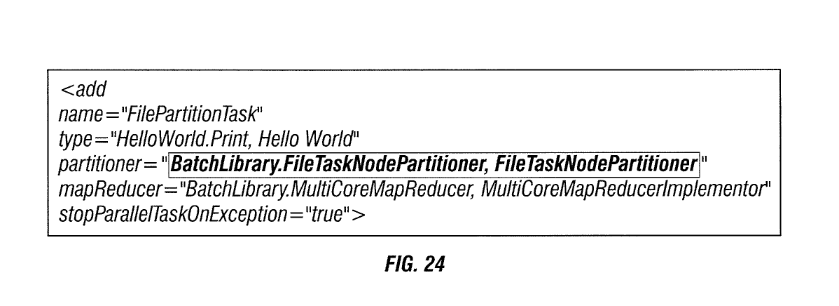

FIG. 23 shows this example configuration with the source file, which is Order.csv in this example, that the partitioner 2200 has partitioned into three files, which are called Partition 1 2302, Partition 2 2304, and Partition 3 2306. These partition files can be used as an input to the multi-core map reducer 220 or grid map reducer 222 for parallel processing on each individual core or nodes of grid to improve application performance. This component is pluggable to any existing PCF integrated or any new application through a simple configuration. FIG. 24 shows a snippet of code that could be used to call the partitioner 2200. This code snippet is shown for example purposes only, but other syntaxes could be used. The partitioner 2200 is particularly useful if there is a huge chunk of data in an input file and there is a necessity of faster processing.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computerized system comprising:
a non-transitory computer-readable medium having a computer program code stored thereon;
a database having stored thereon one or more records that establish a parallel compute framework configuration;
a processor in communication with the computer-readable memory configured to carry out instructions in accordance with the computer program code, wherein the computer program code, when executed by the processor, causes the processor to perform operations comprising:
receiving a request to execute a computing task in parallel by invoking a parallel computer framework (“PCF”) task launcher, wherein the request passes one or more parameters about the computing task to the PCF task launcher;
validating whether the parameters passed to the PCF task launcher are valid based, at least in part, on the parallel compute framework configuration;
responsive to determining the parameters passed to the PCF task launcher are invalid, invoking exception handling to halt execution of the PCF task launcher;
responsive to determining the parameters passed to the PCF task launcher are valid:
partitioning the computing task into a plurality of discrete sub-tasks;
distributing the plurality of discrete sub-tasks to a plurality of processors for execution; and
returning result data from executing the computing task.

2. The computerized system as recited in claim 1, wherein distribution to the plurality of processors is handled based on the parallel compute framework configuration in the database.

3. The computerized system as recited in claim 1, further comprising presenting a dashboard from which one or more parameters of the parallel compute framework configuration in the database can be viewed.

4. The computerized system as recited in claim 1, wherein the plurality of processors are on a plurality of networked computer systems, wherein distribution of the discrete sub-tasks are sent across the plurality of networked computer systems.

5. The computerized system as recited in claim 1, wherein the plurality of processors comprise a plurality of cores within a processor on a stand-alone computer system, wherein distribution of the discrete sub-tasks are sent multiple of the plurality of cores within the processor.

6. The computerized system as recited in claim 1, wherein the parallel compute framework configuration is configured to access a source file as an input parameter, wherein partitioning of the computing task divides the source file into a plurality of chunks that are distributed to respective processors handling respective sub-tasks.

7. A computerized system comprising:
an application programming interface (“API”) exposed on a service oriented architecture of a computer that is configured to receive parameters relating to a business process to be executed in parallel on multiple processors;
a parallel compute framework on a computer in communication with the API that is configured to partition the business process into discrete datasets and distribute the datasets for execution on multiple processors in parallel based on parameters received by the API.

8. The computerized system as recited in claim 7, wherein the parallel compute framework includes a validator configured to determine whether one or more parameters passed to the API are valid.

9. The computerized system as recited in claim 8, wherein the parallel compute framework includes a configuration component configured to set parameters that control how partitioning and distribution of the business process to the multiple processors is handled.

10. The computerized system as recited in claim 9, wherein the parallel compute framework includes a logging component configured to log operations of the API.

11. The computerized system as recited in claim 10, wherein the parallel compute framework includes an auditing component configured to audit actions taken by the API.

12. The computerized system as recited in claim 11, wherein the parallel compute framework includes an exception handling component configured to halt processing if an invalid parameter is passed to the API.

13. The computerized system as recited in claim 7, further comprising a dashboard from which one or more parameters of the parallel compute framework configuration in the database can be viewed.

14. The computerized system as recited in claim 7, wherein the multiple processors are on a plurality of networked computer systems, wherein distribution of the datasets for execution are sent across the plurality of networked computer systems.

15. The computerized system as recited in claim 7, wherein the multiple processors comprise a plurality of cores within a processor on a stand-alone computer system, wherein distribution of the datasets for execution are sent to multiple of the plurality of cores within the processor.

16. A computer program product embedded on a non-transitory computer readable medium comprising:
code configured to pass one or more parameters regarding a business process to an application programming interface (“API”);
code configured to invoke a task launcher responsive to receiving the parameters; and
code configured to partition the business process and distribute tasks of the business process to multiple processors for execution.

17. The computer program product as recited in claim 16, further comprising code configured to determine whether the parameters passed to the API are valid.

18. The computer program product as recited in claim 17, further comprising code configured to audit actions taken by the API.

19. The computer program product as recited in claim 18, further comprising code configured to halt processing if an invalid parameter is passed to the API.

20. The computer program product as recited in claim 19, further comprising code configured to log operations of the API.
